(19) United States
(12) Patent Application Publication
(10) Pub. No.: US 2018/0270835 A1
(43) Pub. Date: Sep. 20, 2018

(54) TECHNIQUES OF CROSS-LINK INTERFERENCE MITIGATION IN FLEXIBLE DUPLEX

(71) Applicant: Mediatek Inc., Hsin-Chu (TW)

(72) Inventors: Bo-Si Chen, Hsinchu (TW); Weidong Yang, San Jose, CA (US); Chien-Chang Li, Hsinchu (TW)

(21) Appl. No.: 15/923,326

(22) Filed: Mar. 16, 2018

Related U.S. Application Data
(60) Provisional application No. 62/472,625, filed on Mar. 17, 2017.

(51) Int. Cl. H04W 72/08; H04W 72/04

(52) U.S. Cl. CPC H04W 72/082; H04W 72/0446

(57) ABSTRACT

A first base station on a first cell determines to communicate in a first direction with one or more UEs on the first cell in a first time slot and a second time slot, the first time slot and the second time slot being consecutive, the one or more UEs including a first UE. The first base station further determines that communication with the first UE on the first cell in the first direction interferes with communication between a second base station and a second UE on a second cell in a second direction. Communication in the second direction having a priority higher that a priority of communication in the first direction. The first base station determines, in the first time slot, to communicate with the one or more UEs on the first cell in the second direction in the second time slot.

### CROSS-REFERENCE TO RELATED APPLICATION(S)

This application claims the benefit of U.S. Provisional Application Ser. No. 62/472,625, entitled “CROSS-LINK INTERFERENCE MITIGATION METHOD IN FLEXIBLE DUPLEX” and filed on Mar. 17, 2017, which is expressly incorporated by reference herein in their entirety.

### BACKGROUND

### Field

The present disclosure relates generally to communication systems, and more particularly, to a base station that dynamically changes a link direction in flexible duplex to mitigate cross-link interference.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a communication system are provided. The communication system includes a first base station on a first cell. The first base station determines, prior to a first time slot and a second time slot, to communicate in a first direction with one or more user equipments (UEs) on the first cell in the first time slot and the second time slot, the first time slot and the second time slot being consecutive, the one or more UEs including a first UE. The first base station further determines that communication with the first UE on the first cell in the first direction interferes with communication between a second base station and a second UE on a second cell in a second direction. Communication in the second direction having a priority higher that a priority of communication in the first direction. The first base station determines, in the first time slot, to communicate with the one or more UEs on the first cell in the second direction in the second time slot.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating a base station in communication with a UE in an access network.

FIG. 4 illustrates an example logical architecture of a distributed access network.

FIG. 5 illustrates an example physical architecture of a distributed access network.

FIG. 6 is a diagram showing an example of a DL-centric subframe.

FIG. 7 is a diagram showing an example of an UL-centric subframe.

FIG. 8 is a diagram illustrating communications between base stations and UEs.

FIG. 9 is diagram illustrating scheduled time slots for communications between the base stations and the UEs when down-link transmission has priority.

FIG. 10 is diagram illustrating scheduled time slots for communications between the base stations and the UEs when up-link transmission has priority.

FIG. 11 is a flow chart of a method (process) for scheduling data transmission between a base station and a UE.

FIG. 12 is a flow chart of another method (process) for scheduling data transmission between a base station and a UE.

FIG. 13 is a conceptual data flow diagram illustrating the data flow between different components/means in an exemplary apparatus.

FIG. 14 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

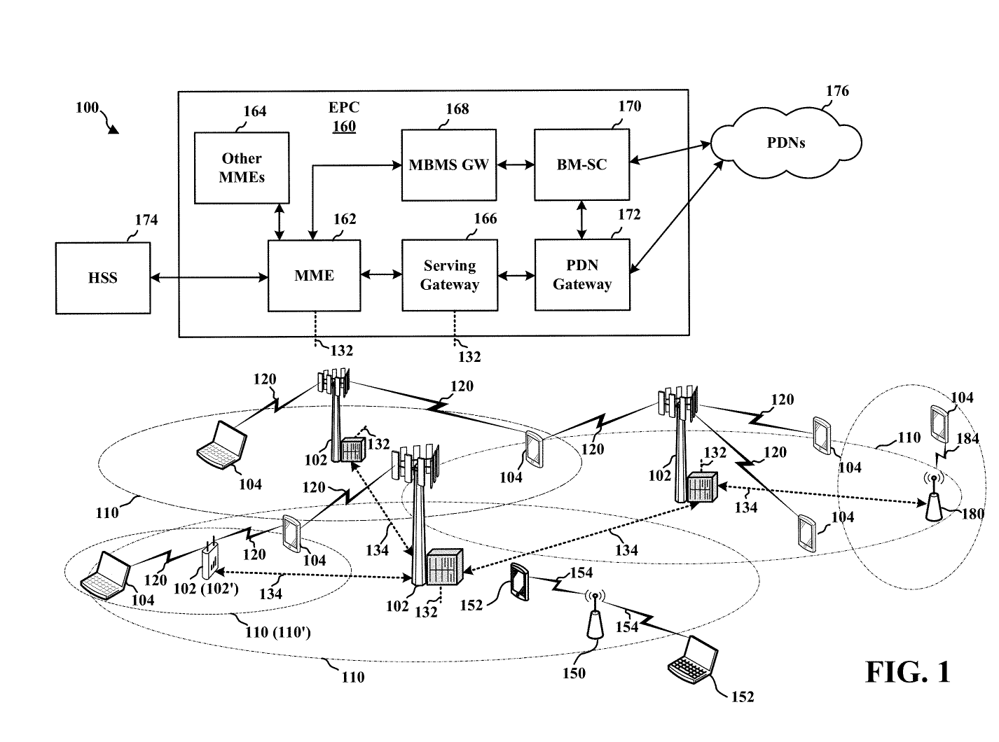

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In certain aspects, the base station 102 is on a first cell. The base station 102 determines, prior to a first time slot and a second time slot, to communicate in a first direction with one or more UEs on the first cell in the first time slot and the second time slot, the first time slot and the second time slot being consecutive, the one or more UEs including a first UE. The base station 102 further determines that communication with the first UE on the first cell in the first direction interferes with communication between a second base station and a second UE on a second cell in a second direction. Communication in the second direction having a priority higher that a priority of communication in the first direction. The base station 102 determines, in the first time slot, to communicate with the one or more UEs on the first cell in the second direction in the second time slot.

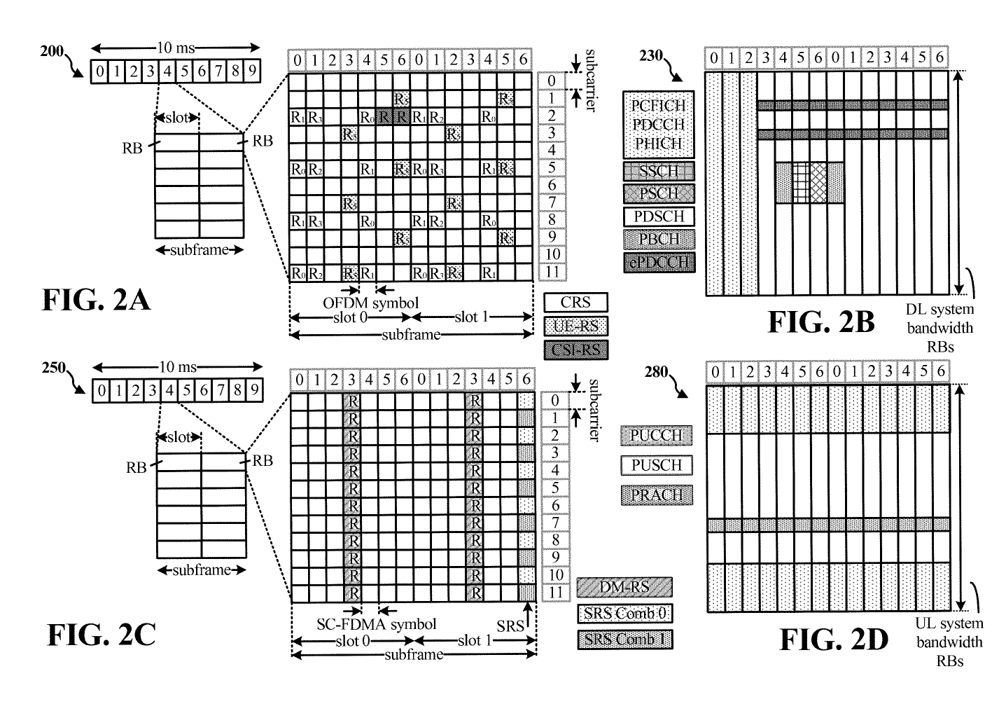

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R0, R1, R2, and R3, respectively), UE-RS for antenna port 5 (indicated as R5), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

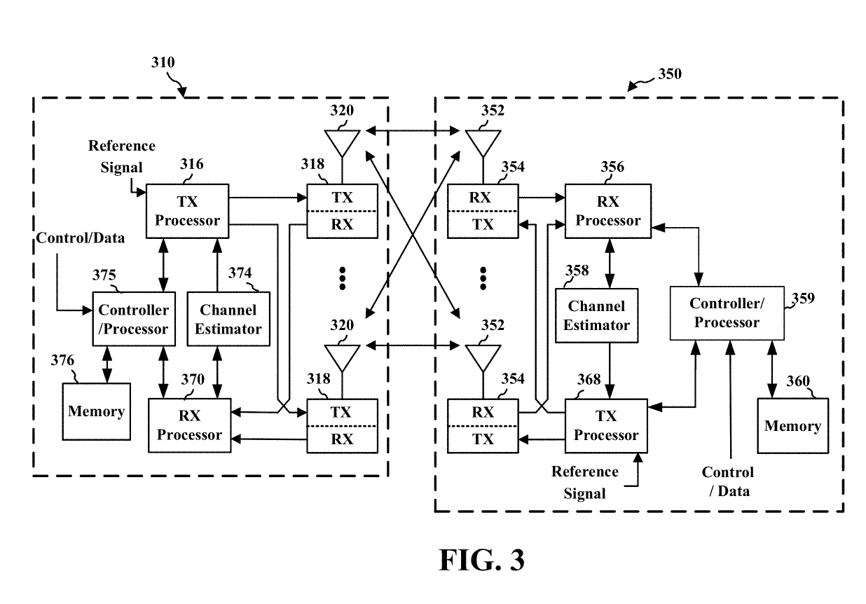

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission. The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

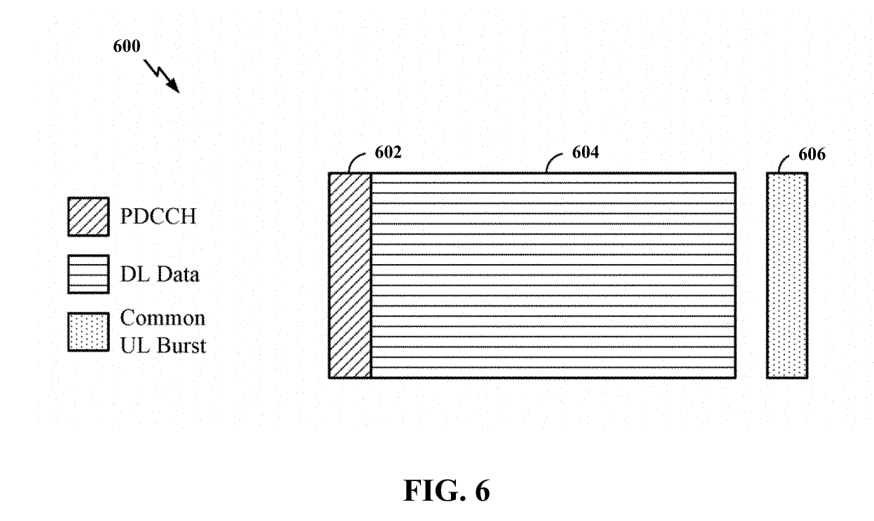

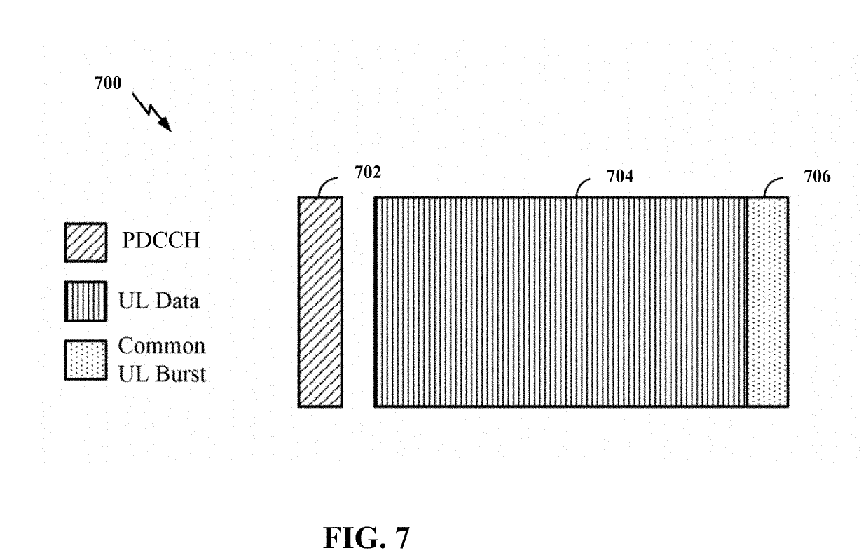

A single component carrier bandwidth of 100 MHZ may be supported. In one example, NR resource blocks (RBs) may span 12 sub-carriers with a sub-carrier bandwidth of 75 kHz over a 0.1 ms duration or a bandwidth of 15 kHz over a 1 ms duration. Each radio frame may consist of 10 or 50 subframes with a length of 10 ms. Each subframe may have a length of 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

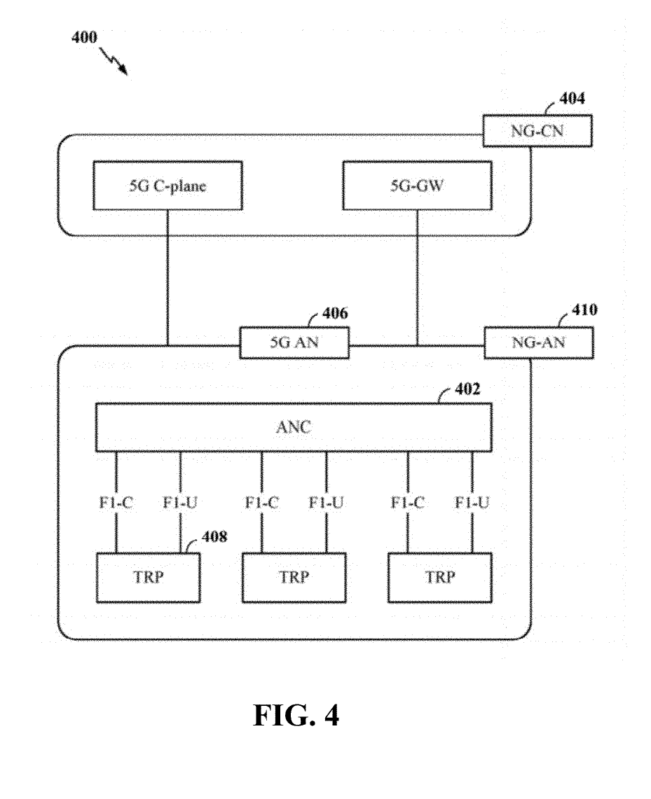

FIG. 4 illustrates an example logical architecture 400 of a distributed RAN, according to aspects of the present disclosure. A 5G access node 406 may include an access node controller (ANC) 402. The ANC may be a central unit (CU) of the distributed RAN 400. The backhaul interface to the next generation core network (NG-CN) 404 may terminate at the ANC. The backhaul interface to neighboring next generation access nodes (NG-ANs) may terminate at the ANC. The ANC may include one or more TRPs 408 (which may also be referred to as BSs, NR BSs, Node Bs, 5G NBs, APs, or some other term). As described above, a TRP may be used interchangeably with “cell.”

The TRPs 408 may be a distributed unit (DU). The TRPs may be connected to one ANC (ANC 402) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 400 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 410 may support dual connectivity with NR. The NG-AN may share a common fronthaul for LTE and NR.

The architecture may enable cooperation between and among TRPs 408. For example, cooperation may be preset within a TRP and/or across TRPs via the ANC 402. According to aspects, no inter-TRP interface may be needed/present.

According to aspects, a dynamic configuration of split logical functions may be present within the architecture of the distributed RAN 400. The PDCP, RLC, MAC protocol may be adaptably placed at the ANC or TRP.

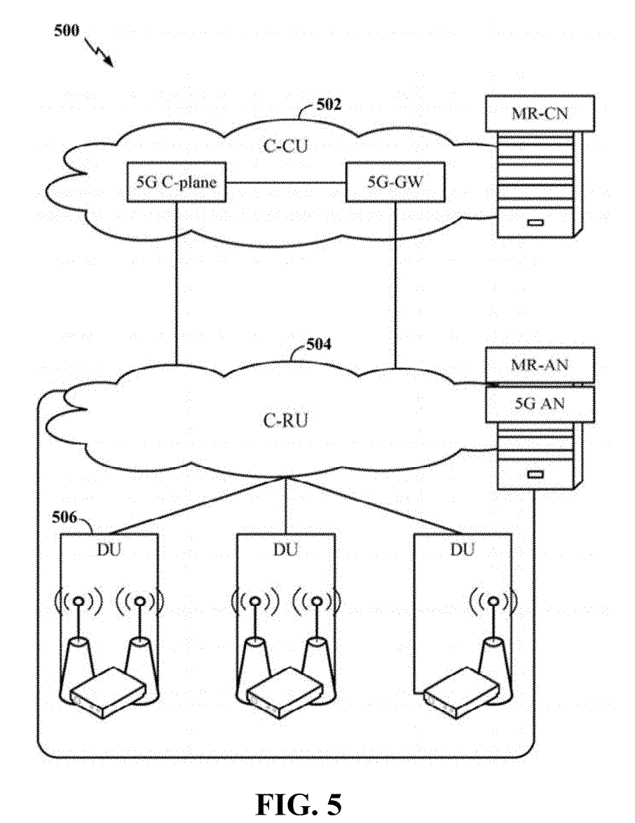

FIG. 5 illustrates an example physical architecture of a distributed RAN 500, according to aspects of the present disclosure. A centralized core network unit (C-CU) 502 may host core network functions. The C-CU may be centrally deployed. C-CU functionality may be offloaded (e.g., to advanced wireless services (AWS)), in an effort to handle peak capacity. A centralized RAN unit (C-RU) 504 may host one or more ANC functions. Optionally, the C-RU may host core network functions locally. The C-RU may have distributed deployment. The C-RU may be closer to the network edge. A distributed unit (DU) 506 may host one or more TRPs. The DU may be located at edges of the network with radio frequency (RF) functionality.

FIG. 6 is a diagram 600 showing an example of a DL-centric subframe. The DL-centric subframe may include a control portion 602. The control portion 602 may exist in the initial or beginning portion of the DL-centric subframe. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe may also include a DL data portion 604. The DL data portion 604 may sometimes be referred to as the payload of the DL-centric subframe. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information.

As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 7 is a diagram 700 showing an example of an UL-centric subframe. The UL-centric subframe may include a control portion 702. The control portion 702 may exist in the initial or beginning portion of the UL-centric subframe. The control portion 702 in FIG. 7 may be similar to the control portion 602 described above with reference to FIG. 6. The UL-centric subframe may also include an UL data portion 704. The UL data portion 704 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 702 may be a physical DL control channel (PDCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 706. The common UL portion 706 in FIG. 7 may be similar to the common UL portion 706 described above with reference to FIG. 7. The common UL portion 706 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

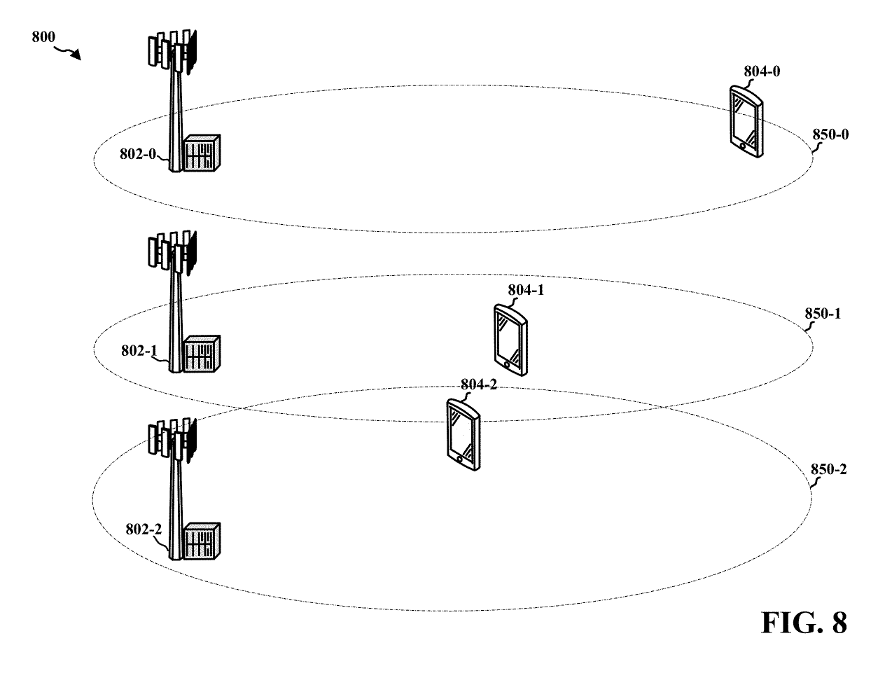

FIG. 8 is a diagram 800 illustrating communications between base stations 802-0, 802-1, 802-2 and UEs 804-0, 804-1, 804-2, respectively. The base stations 802-0, 802-1, 802-2 provides cells 850-0, 850-1, 850-2, respectively. The UEs 804-0, 804-1, 804-2 are connected to the cells 850-0, 850-1, 850-2, respectively. Although in this example three different base stations provides the three different cells, three transmission and reception points (TRPs) on one or more base stations, in another example, may provide the three different cells. Nonetheless, the techniques described infra using different base stations as examples can be equally applied to different TRPs on one or more base stations.

Further, the base stations 802-0, 802-1, 802-2 and the UEs 804-0, 804-1, 804-2 employ flexible duplex techniques. In particular, the base stations 802-0, 802-1, 802-2 and the UEs 804-0, 804-1, 804-2 can schedule a number of consecutive time slots in one of the up-link direction and down-link direction and then a number of time slots in the opposite direction. In one example, the base station schedules two consecutive time slots in one direction and then two consecutive time slots in the opposite direction.

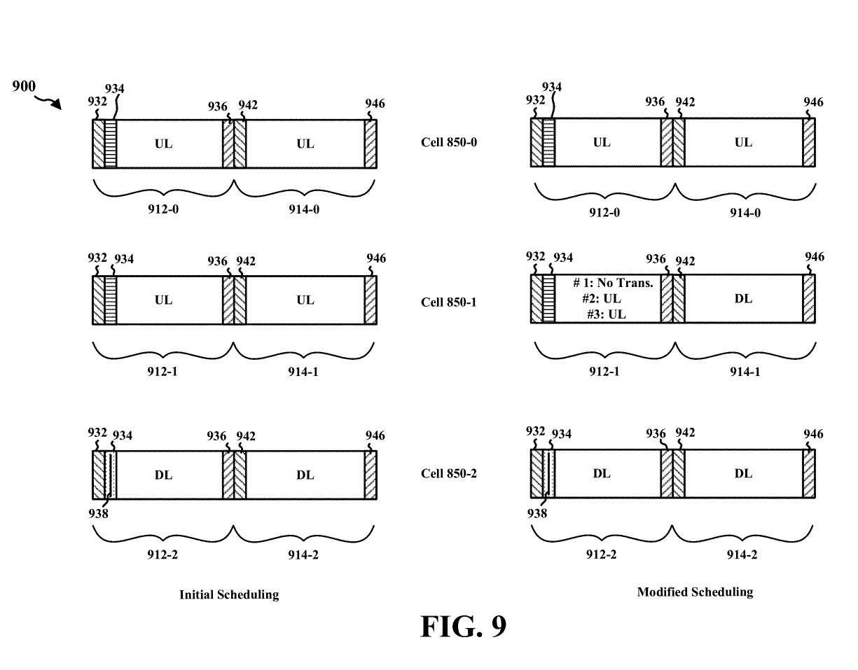

FIG. 9 is diagram 900 illustrating scheduled time slots for communications between the base stations 802-0, 802-1, 802-2 and the UEs 804-0, 804-1, 804-2 when down-link transmission has priority. Initially, the base station 802-0 schedules two consecutive time slots 912-0, 914-0 for communicating with the UEs (including UE 804-0) on the cell 850-0. Similarly, the base station 802-1 schedules two consecutive time slots 912-1, 914-1 for communicating with the UEs (including UE 804-1) on the cell 850-1. The base station 802-2 schedules two consecutive time slots 912-2, 914-2 for communicating with the UEs (including UE 804-2) on the cell 850-2.

Further, the base stations 802-0, 802-1, 802-2 may coordinate with each other such that the time slots 912-0, 914-0, time slots 912-1, 914-1, and the time slots 912-2, 914-2 are aligned. That is, time slots 912-0, 914-0, time slots 912-1, 914-1, and the time slots 912-2, 914-2 each have the same length. Further, the time slot 912-0, time slot 912-1, and time slot 912-2 start at the same time point. The time slot 914-0, time slot 914-1, and time slot 914-2 start at the same time point.

Further, the base stations 802-0, 802-1, 802-2 may be configured with different priority levels for transmissions in the up-link direction and transmissions in the down-link direction. In this example, a transmission in the down-link direction has a priority level higher than that of a transmission in the up-link direction. Further, based on the coordination among the base stations 802-0, 802-1, 802-2, prior to the time slot 912-2 and the time slot 914-2, the base station 802-2 schedules the time slots 912-2, 914-2 for transmission in the down-link direction, while the base station 802-0 and the base station 802-1 schedule the time slots 912-0, 914-0 and the time slots 912-1, 914-1 for transmission in the up-link direction.

In a first technique, a base station communicating in the direction having a higher priority level may transit a signal (e.g., a busy tone) in the first time slot of a sequence of time slots in that direction to reduce interferences generated from other cells as described infra. In this example, in a time period 932, which is at the beginning of the time slot 912-0/time slot 912-1/time slot 912-2, each of the base stations 802-0, 802-1, 802-2 transmits down link control channels. In a time period 934 subsequent and consecutive to the time period 932, the base station 802-2 transmits a busy tone 938 (e.g., across the available bandwidth), while the UE 804-0 and the UE 804-1 each perform a clear channel access (CCA) operation prior to transmitting data in the up-link direction in the time slot 912-0/time slot 912-1 as scheduled. Further, the time period 934 also functions as a guard period.

In the time period 934, the UE 804-0 and the UE 804-1 detect the busy tone 938 transmitted by the base station 802-2. Based on the characteristics (e.g., power level) of the received busy tone 938, the UE 804-0 and the UE 804-1 can estimate the distance or locations of the base station 802-2 and/or the UEs connected to the cell 850-2 provided by the base station 802-2. The UE 804-0 and the UE 804-1 then can further estimate whether their scheduled transmissions in the up-link direction to the base station 802-0 in the time slots 912-0, 914-0 and to the base station 802-1 in the time slots 912-1, 914-1, respectively, would interfere with the transmission from the base station 802-2 to the UE 804-2 in the down-link direction (which has a higher priority level) in the time slots 912-2, 914-2.

In this example, the UE 804-0 detects that the power level of the received busy tone 938 is not above a pre-configured threshold. Accordingly, the UE 804-0 transmits data to the base station 802-0 in the up-link direction in the time slots 912-0, 914-0 as scheduled.

On the other hand, the UE 804-1 detects that the power level of the received busy tone 938 is above a pre-configured threshold. The UE 804-1 then determines that transmission from the UE 804-1 in the time slots 912-1, 914-1 in the up-link direction would interfere with the reception at the UE 804-2 of the transmission from the base station 802-2 in the down-link direction. Accordingly, the UE 804-1 may determine to refrain from transmitting data to the base station 802-1 in the time slot 912-1. As such, the base station 802-1 can detect that the UE 804-1 does not transmit up-link data in the time slot 912-1 as scheduled. Based on this, the base station 802-1 can know that transmission from the UE 804-1 in the time slots 912-1, 914-1 in the up-link direction would interfere with the reception at the UE 804-2 of the transmission from the base station 802-2 in the down-link direction. Accordingly, the base station 802-1 may further communicate with the UE 804-1 to re-schedule the time slot 914-1 for transmission in the down-link direction. That is, the direction of the transmission is changed from the up-link direction to the down-link direction in the time slot 914-1. For example, the base stations 802-0, 802-1, 802-2 may transmit down-link control channels in a time period 942 at the beginning of the time slot 914-0/time slot 914-1/time slot 914-2. The base station 802-1 may reschedule the time slot 914-1 with the UE 804-1 for down-link transmission through the down-link control channels transmitted in the time period 942. Further, in certain configurations, the UEs 804-0, 804-1, 804-2 may transmit up-link control channels in a time period 936 at the end of the time slot 912-0/time slot 912-1/time slot 912-2 as well as a time period 946 at the end of the time slot 914-0/time slot 914-1/time slot 914-2.

In a second technique, as described supra, the base station 802-0 schedules, at a time point prior to the time slot 912-0/time slot 912-1/time slot 912-2, two consecutive time slots 912-0, 914-0 for communicating with the UEs (including UE 804-0) on the cell 850-0; the base station 802-1 schedules two consecutive time slots 912-1, 914-1 for communicating with the UEs (including UE 804-1) on the cell 850-1; the base station 802-2 schedules two consecutive time slots 912-2, 914-2 for communicating with the UEs (including UE 804-2) on the cell 850-2. In this technique, in the time slot 912-0/time slot 912-1/time slot 912-2, the base stations 802-0, 802-1, 802-2 communicate with their respective UEs as scheduled. In particular, the base station 802-0 operates to receive data from the UE 804-0 in the up-link direction in the time slot 912-0. The base station 802-1 operates to receive data from the UE 804-1 in the up-link direction in the time slot 912-1. The base station 802-2 operates to transmit data to the UE 804-2 in the down-link direction in the time slot 912-2.

The UE 804-0 and the UE 804-1 transmit data in the up-link direction, which has a priority level lower than that of the down-link direction. Accordingly, the base station 802-0 and the base station 802-1 can measure an interference level while receiving data in the time slot 912-0/time slot 912-1. In one implementation, the base station 802-0 and the base station 802-1 may, in the time slot 912-0/time slot 912-1, measure specific reference signals contained in, and identifying, the down-link transmission from the base station 802-2 to determine an interference level at the base station 802-0 and the base station 802-1, respectively.

For example, the base station 802-0 may measure the specific reference signals from the down-link transmission of the base station 802-2 to determine the interference level at the base station 802-0 caused by the base station 802-2. Further, the base station 802-0 may estimate whether data transmission from the UE 804-0 would cause interference to receiving data from the base station 802-2 at the UE 804-2 based on the measured interference level. In this example, based on the received reference signals sent from the base station 802-2 in the time slot 912-2, the base station 802-0 estimates that up-link data transmission from the UE 804-0 would not cause interference to receiving data from the base station 802-2 at the UE 804-2. Therefore, the base station 802-0 maintains the scheduling of the time slot 914-0 for receiving up-link data from the UE 804-0.

Similarly, the base station 802-1 measures the reference signals from the down-link transmission of the base station 802-2 to determine the interference level at the base station 802-1 caused by the base station 802-2. Further, in this example, based on the received reference signals sent from the base station 802-2 in the time slot 912-2, the base station 802-1 estimates that up-link data transmission from the UE 804-1 would cause interference to receiving data from the base station 802-2 at the UE 804-2 in the down-link direction. The base station 802-1 may be configured to, in this circumstance, communicate with the UE 804-1 to re-schedule the time slot 914-1 for transmission in the down-link direction. That is, the direction of the transmission is changed from up-link direction to down-link direction in the time slot 914-1. In particular, the base station 802-1 may send down-link control channels in the time period 942 at the beginning of the time slot 914-0/time slot 914-1/time slot 914-2. Through the down-link control channels in the time period 942, the base station 802-1 schedules the time slot 914-1 for down-link transmission from the base station 802-1 to the UE 804-1.

In a third technique, as described supra, the base station 802-0 schedules, at a time point prior to the time slot 912-0/time slot 912-1/time slot 912-2, two consecutive time slots 912-0, 914-0 for communicating with the UEs (including UE 804-0) on the cell 850-0; the base station 802-1 schedules two consecutive time slots 912-1, 914-1 for communicating with the UEs (including UE 804-1) on the cell 850-1; the base station 802-2 schedules two consecutive time slots 912-2, 914-2 for communicating with the UEs (including UE 804-2) on the cell 850-2. In this technique, in the time slot 912-0/time slot 912-1/time slot 912-2, the base stations 802-0, 802-1, 802-2 communicate with their respective UEs as scheduled. In particular, the base station 802-0 operates to receive data from the UE 804-0 in the up-link direction in the time slot 912-0. The base station 802-1 operates to receive data from the UE 804-1 in the up-link direction in the time slot 912-1. The base station 802-2 operates to transmit data to the UE 804-2 in the down-link direction in the time slot 912-2.

Further, in this third technique, the base stations communicating data in the direction that has the lower priority level (e.g., the up-link direction in this example) monitor whether the communications with the UEs were successful. As described supra, the base station 802-0 may be in communication with one or more UEs (including the UE 804-0) in the cell 850-0. The base station 802-0 monitors whether an up-link transmission from each of the one or more UEs has been successfully received by the base station 802-0 in the time slot 912-0. The base station 802-0 may calculate a packet loss rate based on the transmission status of the one or more UEs in the cell 850-0. For example, there may be four more UEs in the cell 850-0 in addition to the UE 804-0 (i.e., totally five UEs). Packets sent from three of the five UEs in the time slot 912-0 have been successfully received at the base station 802-0; packets sent from two of the five UEs in the time slot 912-0 were not successfully received at the base station 802-0. In this example, the base station 802-0 may determine that the packet loss rate is 0.4. When the packet loss rate is above a threshold, the base station 802-0 may determine that the transmission in the down-link direction from the base station 802-2 interferes with the reception of up-link data at the base station 802-0. Base on that determination, the base station 802-0 can further estimate that the up-link transmissions at the UE 804-0 and any other UEs would similarly interfere with the down-link reception at the UE 804-2. In this example, the base station 802-0 determines that the packet loss rate is not above the threshold and, accordingly, that the up-link transmission from the UE 804-0 does not interfere with the down-link reception at the UE 804-2. Therefore, the base station 802-0 and the UE 804-0 continue communicating data in the up-link direction in the time slot 914-0-.

Further, in this example, the base station 802-1 monitors whether an up-link transmission from each of the one or more UEs (including the UE 804-1) in the cell 850-1 has been successfully received by the base station 802-1 in the time slot 912-1. The base station 802-1 may similarly calculate a packet loss rate based on the up-link transmission status of the one or more UEs in the cell 850-1, as described supra regarding the base station 802-0. In this example, the base station 802-1 determines that the packet loss rate at the base station 802-1 is above the threshold and, accordingly, that the up-link transmissions from the UE 804-1 and other UEs interfere with the down-link reception at the UE 804-2. Therefore, the base station 802-1 may determine to change the transmission direction in the time slot 914-1 to reduce interference. That is, the base station 802-1 communicates with the UE 804-1 to re-schedule the time slot 914-1 for transmission in the down-link direction. The direction of the transmission is changed from the up-link direction to the down-link direction. For example, through the down-link control channels in the time period 942, the base station 802-1 can schedule the time slot 914-1 for down-link transmission from the base station 802-1 to the UE 804-1.

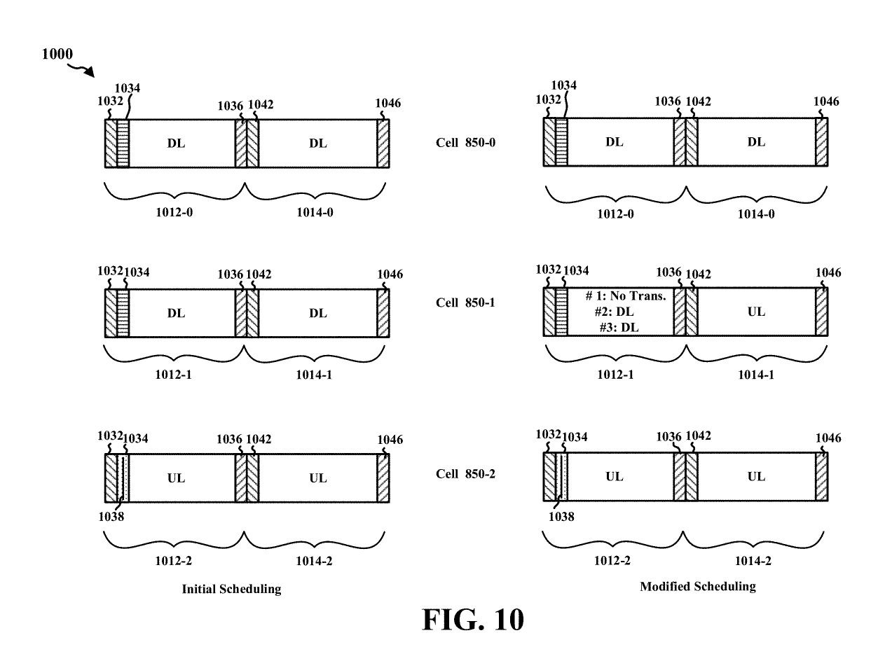

FIG. 10 is diagram 1000 illustrating scheduled time slots for communications between the base stations 802-0, 802-1, 802-2 and the UEs 804-0, 804-1, 804-2 when up-link transmission has priority. Initially, the base station 802-0 schedules two consecutive time slots 1012-0, 1014-0 for communicating with the UEs (including UE 804-0) on the cell 850-0. Similarly, the base station 802-1 schedules two consecutive time slots 1012-1, 1014-1 for communicating with the UEs (including UE 804-1) on the cell 850-1. The base station 802-2 schedules two consecutive time slots 1012-2, 1014-2 for communicating with the UEs (including UE 804-2) on the cell 850-2.

Further, the base stations 802-0, 802-1, 802-2 may coordinate with each other such that the time slots 1012-0, 1014-0, time slots 1012-1, 1014-1, and the time slots 1012-2, 1014-2 are aligned. That is, time slots 1012-0, 1014-0, time slots 1012-1, 1014-1, and the time slots 1012-2, 1014-2 each have the same length. Further, the time slot 1012-0, time slot 1012-1, and time slot 1012-2 start at the same time point. The time slot 1014-0, time slot 1014-1, and time slot 1014-2 start at the same time point.

In this example, a transmission in the up-link direction has a priority level higher than that of a transmission in the down-link direction. Further, based on the coordination among the base stations 802-0, 802-1, 802-2, prior to the time slot 1012-2 and the time slot 1014-2, the base station 802-2 schedules the time slots 1012-2, 1014-2 for transmission from the UE 804-2 in the up-link direction, while the base station 802-1 and the base station 802-2 schedule the time slots 1012-0, 1014-0 and the time slots 1012-1, 1014-1 for transmission in the down-link direction.

In a first technique, in a time period 1032, which is at the beginning of the time slot 1012-0/time slot 1012-1/time slot 1012-2, each of the base stations 802-0, 802-1, 802-2 transmits down link control channels. In a time period 1034 subsequent to the time period 1032, the base station 802-2 transmits a busy tone 1038, while the base station 802-0 and the base station 802-1 perform a CCA operation. Further, the time period 1034 also functions as a guard period.

In the time slot 1012-1, the base station 802-0 and the base station 802-1 detect the busy tone 1038 transmitted by the base station 802-2. Based on the characteristics (e.g., a power level) of the received busy tone 1038, the base station 802-0 and the base station 802-1 can estimate the distance or locations of the base station 802-2 and/or the UEs connected to the cell 850-2. The base station 802-0 and the base station 802-1 then can further estimate whether a scheduled transmission in the down-link direction to the UE 804-0 in the time slots 1012-0, 1014-0 and to the UE 804-1 in the time slots 1012-1, 1014-1, respectively, would interfere reception of the up-link transmission (which has a higher priority level) from the UE 804-2 at the base station 802-2 in the time slots 1012-2, 1014-2.

In this example, the base station 802-0 detects that the power level of the received busy tone 1038 is not above a pre-configured threshold. Accordingly, the base station 802-0 determines that the transmission at the base station 802-0 in the down-link direction does not interfere with the reception of the transmission from the UE 804-2 at the base station 802-2 in the up-link direction. Accordingly, the base station 802-0 communicates with the UE 804-0 in the down-link direction in the time slots 1012-0, 1014-0 as scheduled.

On the other hand, the base station 802-1 detects that the power level of the received busy tone 1038 is above a pre-configured threshold. The base station 802-1 then determines that in the time slots 1012-1, 1014-1 transmission from the base station 802-1 in the down-link direction would interfere with the reception of the transmission from the UE 804-2 at the base station 802-2 in the up-link direction. Accordingly, the base station 802-1 may determine to refrain from transmitting data to the UE 804-1 in the time slot 1012-1. Further, the base station 802-1 may further communicate with the UE 804-1 to re-schedule the time slot 1014-1 for transmission in the up-link direction. That is, the direction of the transmission in the time slot 1014-1 is changed from down-link direction to up-link direction. For example, the base stations 802-0, 802-1, 802-2 may transmit down-link control channels in a time period 1042 at the beginning of the time slot 1014-0/time slot 1014-1/time slot 1014-2. The base station 802-1 may reschedule the time slot 1014-1 with the UE 804-1 for up-link transmission through the down-link control channels transmitted in the time period 1042. Further, in certain configurations, the UEs 804-0, 804-1, 804-2 may transmit up-link control channels in a time period 1036 at the end of the time slot 912-0/time slot 912-1/time slot 912-2 as well as a time period 1046 at the end of the time slot 914-0/time slot 914-1/time slot 914-2.

In a second technique, as described supra, the base station 802-0 schedules, at a time point prior to the time slot 1012-0/time slot 1012-1/time slot 1012-2, two consecutive time slots 1012-0, 1014-0 for communicating with the UEs (including UE 804-0) on the cell 850-0; the base station 802-1 schedules two consecutive time slots 1012-1, 1014-1 for communicating with the UEs (including UE 804-1) on the cell 850-1; the base station 802-2 schedules two consecutive time slots 1012-2, 1014-2 for communicating with the UEs (including UE 804-2) on the cell 850-2. In this technique, in the time slot 1012-0/time slot 1012-1/time slot 1012-2, the base stations 802-0, 802-1, 802-2 communicates with their respective UEs as scheduled. In particular, the base station 802-0 operates to transmit data to the UE 804-0 in the down-link direction in the time slot 1012-0. The base station 802-1 operates to transmit data to the UE 804-1 in the down-link direction in the time slot 1012-1. The base station 802-2 operates to receive data from the UE 804-2 in the up-link direction in the time slot 1012-2.

The base station 802-0 and the base station 802-1 transmit data in the down-link direction, which has a priority level lower than that of the up-link direction. Accordingly, the UE 804-0 and the UE 804-1 can measure interference level in the time slot 1012-0/time slot 1012-1. In one implementation, the UE 804-0 and the UE 804-1 may measure specific reference signals contained in the up-link transmission from the UE 804-2 in the time slot 1012-1 to determine an interference level at the UE 804-0 and the UE 804-1, respectively.

For example, the UE 804-0 may measure the specific reference signals from the up-link transmission of the UE 804-2 to determine the interference level at the UE 804-0 caused by the UE 804-2. Further, the UE 804-0 may send the determined interference level to the base station 802-0. For example, the UEs 804-0, 804-1, 804-2 may be configured to send up-link control channels to the base stations 802-0, 802-1, 802-2, respectively, in the time period 1036 at the end of the time slot 912-0/time slot 912-1/time slot 912-2. The determined interference level may be included in the up-link control channel sent from the UE 804-0 to the base station 802-0. The base station 802-0 may estimate whether data transmission from the base station 802-0 would cause interference to receiving data from the UE 804-2 at the base station 802-2 based on the measured interference level. In this example, based on the received reference signals sent from the UE 804-2 in the time slot 1012-2, the base station 802-0 estimates that down-link data transmission from the base station 802-0 would not cause interference to receiving data from the UE 804-2 at the base station 802-2 in the up-link direction. Therefore, the base station 802-0 maintains the time slot 1014-0 for transmitting down-link data to the UE 804-0 as scheduled.

Similarly, the UE 804-1 measures the reference signals from the up-link transmission of the UE 804-2 to determine the interference level at the UE 804-1 caused by the UE 804-2. As described supra, the UE 804-1 sends the measured interference level to the base station 802-1 through the up-link control channels sent in the time period 1036.

The base station 802-1 may estimate whether data transmission from the base station 802-1 would cause interference to receiving data from the UE 804-2 at the base station 802-2 based on the measured interference level. In this example, based on the received measured interference level sent from the UE 804-1 in the time slot 1012-1, the base station 802-0 estimates that down-link data transmission from the base station 802-1 would cause interference to receiving data from the UE 804-2 at the base station 802-2 in the up-link direction. The base station 802-1 may be configured to, in this circumstance, communicate with the UE 804-1 to re-schedule the time slot 1014-1 for transmission in the up-link direction. That is, the direction of the transmission is changed from down-link direction to up-link direction in the time slot 1014-1. In particular, the base station 802-1 may send down-link control channels in a time period 1042 at the beginning of the time slot 1014-0/time slot 1014-1/time slot 1014-2. Through the down-link control channels, the base station 802-1 schedules the time slot 1014-1 for up-link transmission from the UE 804-1 to the base station 802-1.

In a third technique, as described supra, the base station 802-0 schedules, at a time point prior to the time slot 1012-0/time slot 1012-1/time slot 1012-2, two consecutive time slots 1012-0, 1014-0 for communicating with the UEs (including UE 804-0) on the cell 850-0; the base station 802-1 schedules two consecutive time slots 1012-1, 1014-1 for communicating with the UEs (including UE 804-1) on the cell 850-1; the base station 802-2 schedules two consecutive time slots 1012-2, 1014-2 for communicating with the UEs (including UE 804-2) on the cell 850-2. In this technique, in the time slot 1012-0/time slot 1012-1/time slot 1012-2, the base stations 802-0, 802-1, 802-2 communicates with their respective UEs as scheduled. In particular, the base station 802-0 operates to transmit data to the UE 804-0 in the down-link direction in the time slot 1012-0. The base station 802-1 operates to transmit data to the UE 804-1 in the down-link direction in the time slot 1012-1. The base station 802-2 operates to receive data from the UE 804-2 in the up-link direction in the time slot 1012-2.

Further, in this third technique, the base stations communicating data in the direction that has the lower priority level (e.g., the down-link direction in this example) monitor whether the communications with the UEs were successful. As described supra, the base station 802-0 may be in communication with one or more UEs (including the UE 804-0) in the cell 850-0. The base station 802-0 monitors whether a respective down-link transmission to each of the one or more UEs has been successfully received in the time slot 1012-0 by the respective, corresponding UE. In particular, based on the ACKs/NACKs received from each of the one or more UEs, the base station 802-0 may determine whether the down-link transmission to that UE was successful. The base station 802-0 may calculate a packet loss rate based on the transmission status to the one or more UEs in the cell 850-0. For example, there may be four more UEs in the cell 850-0 in addition to the UE 804-0 (i.e., totally five UEs). Packets sent to three of the five UEs in the time slot 912-0 have been successfully received at the UEs; packets sent to two of the five UEs in the time slot 912-0 were not successfully received at the base station 802-0. In this example, the base station 802-0 may determine that the packet loss rate is 0.4. When the packet loss rate is greater than a pre-configured threshold, the base station 802-0 may determine that the transmission in the up-link direction from the UE 804-2 interferes with the reception of down-link data at the UE 804-0 and/or other UEs. Base on that determination, the base station 802-0 can further estimate that the down-link transmission at the base station 802-0 would similarly interfere with the up-link direction reception at the base station 802-2. In this example, the base station 802-0 determines that the packet loss rate is not above the threshold and, accordingly, that the down-link transmission from the base station 802-0 does not interfere with the up-link reception at the base station 802-2. Therefore, the base station 802-0 and the UE 804-0 continue communicating data in the down-link direction in the time slot 1014-0 as scheduled.

Further, in this example, the base station 802-1 monitors whether a respective down-link transmission to each of the one or more UEs (including the UE 804-1) in the cell 850-1 has been successfully received in the time slot 1012-1 by the respective, corresponding UE. The base station 802-1 may similarly calculate a packet loss rate based on the down-link transmission status to the one or more UEs in the cell 850-1, as described supra regarding the base station 802-0. In this example, the base station 802-1 determines that the packet loss rate at the UE 804-1 and/or other UEs for receiving the down-link transmissions from the base station 802-1 is above the threshold and, accordingly, that the down-link transmissions from the base station 802-1 interfere with the up-link reception at the base station 802-2. Therefore, the base station 802-1 may determine to change the transmission direction in the time slot 1014-1 to reduce interference. That is, the base station 802-1 communicates with the UE 804-1 to re-schedule the time slot 1014-1 for transmission in the up-link direction (e.g., through the down-link control channels in the time period 1042). The direction of the transmission is changed from down-link direction to up-link direction.

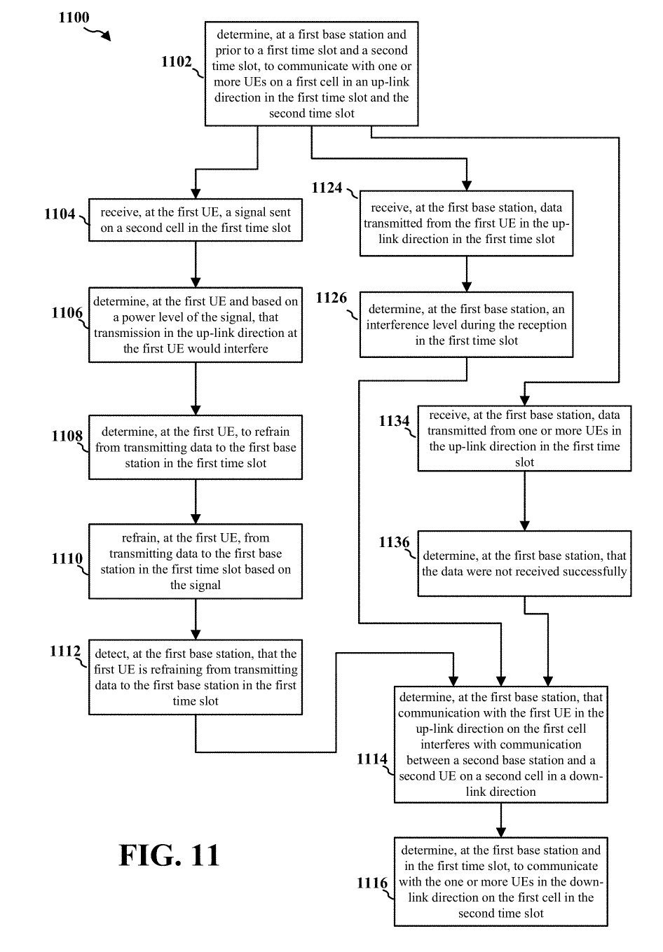

FIG. 11 is a flow chart 1100 of a method (process) for scheduling data transmission between a base station and a UE. The method may be performed by a wireless communication system. The wireless communication system includes a first base station (e.g., the base station 802-1, the apparatus 1302, and the apparatus 1302′) of a first cell (e.g., the cell 850-1).

At operation 1102, the first base station determines, prior to a first time slot and a second time slot (the time slots 912-1, 914-1), to communicate with one or more UEs on the first cell in an up-link direction in the first time slot and the second time slot, the first time slot and the second time slot being consecutive, the one or more UEs including a first UE (e.g., the UE 804-1).

In a first technique, the wireless communication system further includes a first UE. At operation 1104, the first UE receives a signal (e.g., the busy tone 938) sent in the first time slot on a second cell. At operation 1106, the first UE determines, based on a power level of the signal, that transmission in the up-link direction at the first UE would interfere with receiving data in the down-link direction at a second UE (e.g., the UE 804-2) on the second cell (e.g., the cell 850-2). The communication in the down-link direction has a priority higher that a priority of communication in the up-link direction.

At operation 1108, the first UE determines to refrain from transmitting data to the first base station in the first time slot. At operation 1110, the first UE refrains from transmitting data to the first base station in the first time slot based on the signal. At operation 1112, the first base station detects that the first UE is refraining from transmitting data to the first base station in the first time slot.

At operation 1114, the first base station determines that communication with the first UE in the up-link direction on the first cell interferes with communication between a second base station (e.g., the base station 802-2) and the second UE in the down-link direction on the second cell. At operation 1116, the first base station determines, in the first time slot, to communicate with the one or more UEs in the down-link direction on the first cell in the second time slot.

In a second technique, subsequent to operation 1102 and at operation 1124, the first base station receives data transmitted from the first UE in the up-link direction in the first time slot. At operation 1126, the first base station determines an interference level during the reception in the first time slot. Based on the interference level, the first base station proceed with operation 1114.

In a third technique, subsequent to operation 1102 and at operation 1134, the first base station receives data transmitted from the one or more UEs (e.g., the one or more UEs in the cell 850-1) in the up-link direction in the first time slot. At operation 1136, the first base station determines that the data were not received successfully (e.g., the base station 802-1 determines that the packet loss rate is above a pre-configured threshold). Based on that determination, the first base station proceeds with operation 1114.

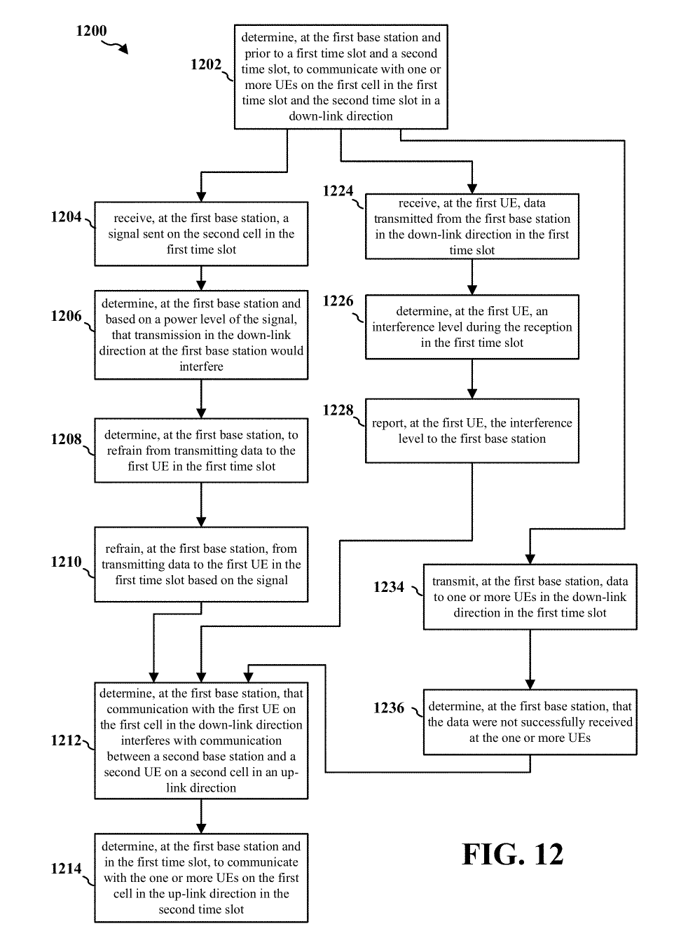

FIG. 12 is a flow chart 1200 of another method (process) for scheduling data transmission between a base station and a UE. The method may be performed by a wireless communication system. The wireless communication system includes a first base station (e.g., the base station 802-1, the apparatus 1302, and the apparatus 1302′) of a first cell (e.g., the cell 850-1).

At operation 1202, the first base station determines, prior to a first time slot and a second time slot (the time slots 1012-1, 1014-1), to communicate in a down-link direction with one or more UEs on the first cell in the first time slot and the second time slot, the first time slot and the second time slot being consecutive, the one or more UEs including a first UE (the UE 804-1).

In a first technique, at operation 1204, the first base station receives a signal (e.g., the busy tone 1038) sent in the first time slot on a second cell (e.g., the cell 850-2). At operation 1206, the first base station determines, based on a power level of the signal, that transmission in the down-link direction at the first base station would interfere with receiving data in the up-link direction at a second base station (e.g., the base station 802-2) on the second cell.

At operation 1208, the first base station determines to refrain from transmitting data to the first UE in the first time slot. At operation 1210, the first base station refrains from transmitting data to the first UE in the first time slot based on the signal.

At operation 1212, the first base station determines that communication with the first UE in the down-link direction on the first cell interferes with communication between the second base station and the second UE in the up-link direction on a second cell. At operation 1214, the first base station determines, in the first time slot, to communicate with the one or more UEs in the up-link direction on the first cell in the second time slot.

In a second technique, the wireless communication system further includes the first UE. Subsequent to operation 1202 and at operation 1224, the first UE receives data transmitted from the first base station in the down-link direction in the first time slot. At operation 1226, the first UE determines an interference level during the reception in the first time slot. At operation 1228, the first UE reports the interference level to the first base station. Upon receiving the reported interference level, the first base station proceeds with operation 1212.

In a third technique, subsequent to operation 1202 and at operation 1234, the first base station transmits data to the one or more UEs (e.g., the UEs in the cell 850-1) in the down-link direction in the first time slot. At operation 1236, the first base station determines that the data were not successfully received at the one or more UEs (e.g., the base station 802-1 determines that the packet loss rate based on ACKs/NACKs received from the one or more UEs; the base station 802-1 further determines that the packet loss rate is above a pre-configured threshold). Based on that determination, the first base station proceeds with operation 1212.

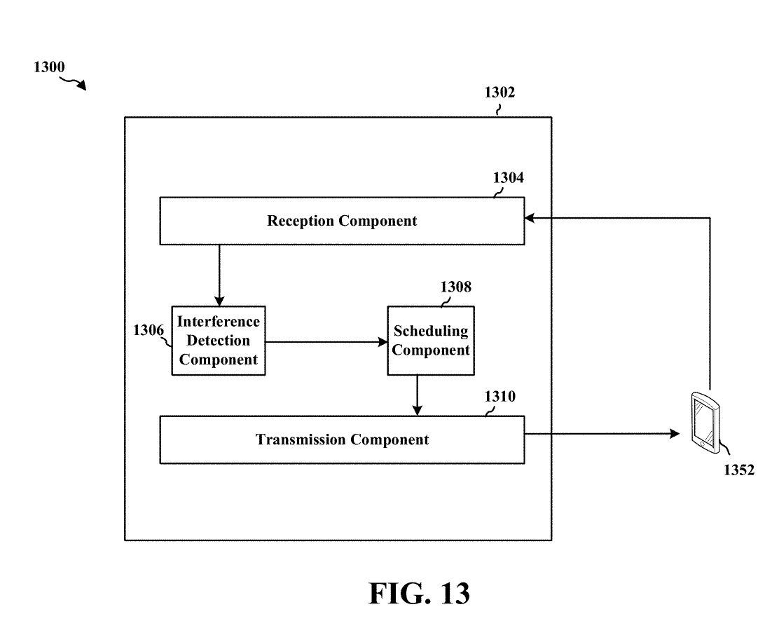

FIG. 13 is a conceptual data flow diagram 1300 illustrating the data flow between different components/means in an exemplary apparatus 1302. The apparatus 1302 may be a first base station. The apparatus 1302 includes a reception component 1304, an interference detection component 1306, a scheduling component 1308, and a transmission component 1310.

In one aspect, the scheduling component 1308 determines, prior to a first time slot and a second time slot, to communicate in an up-link direction with one or more UEs on the first cell in the first time slot and the second time slot, the first time slot and the second time slot being consecutive, the one or more UEs including a UE 1352.

In a first technique, the UE 1352 receives a signal sent in the first time slot on a second cell. The UE 1352 determines, based on a power level of the signal, that transmission in the up-link direction at the UE 1352 would interfere with receiving data in the down-link direction at a second UE on the second cell. The communication in the down-link direction has a priority higher that a priority of communication in the up-link direction. The UE 1352 determines to refrain from transmitting data to the first base station in the first time slot.

The UE 1352 refrains from transmitting data to the first base station in the first time slot based on the signal. The interference detection component 1306 of the apparatus 1302 detects that the UE 1352 is refraining from transmitting data to the first base station in the first time slot. The interference detection component 1306 determines that communication with the UE 1352 in the up-link direction on the first cell interferes with communication between a second base station and the second UE in the down-link direction on a second cell. The scheduling component 1308 determines, in the first time slot, to communicate with the one or more UEs in the down-link direction on the first cell in the second time slot.

In a second technique, the reception component 1304 of the apparatus 1302 receives data transmitted from the UE 1352 in the up-link direction in the first time slot. The interference detection component 1306 determines an interference level during the reception in the first time slot. Based on the interference level, the scheduling component 1308 determines, in the first time slot, to communicate with the one or more UEs on the first cell in the down-link direction in the second time slot.

In a third technique, the reception component 1304 of the apparatus 1302 receives data transmitted from the one or more UEs in the up-link direction in the first time slot. The interference detection component 1306 determines that the data were not received successfully. Based on that determination, the scheduling component 1308 determines, in the first time slot, to communicate with the one or more UEs on the first cell in the down-link direction in the second time slot.

In another aspect, the scheduling component 1308 of the apparatus 1302 determines, prior to a first time slot and a second time slot, to communicate in a down-link direction with one or more UEs on a first cell in the first time slot and the second time slot, the first time slot and the second time slot being consecutive, the one or more UEs including a UE 1352.

In a first technique, the reception component 1304 receives a signal sent in the first time slot on a second cell. The interference detection component 1306 determines, based on a power level of the signal, that transmission in the down-link direction at the first base station would interfere with receiving data in the up-link direction at a second base station on the second cell.

The scheduling component 1308 determines to refrain from transmitting data to the UE 1352 in the first time slot. The transmission component 1310 refrains from transmitting data to the UE 1352 in the first time slot based on the signal.

The scheduling component 1308 determines that communication with the UE 1352 in the down-link direction on the first cell interferes with communication between the second base station and the second UE in the up-link direction on a second cell.

The scheduling component 1308 determines, in the first time slot, to communicate with the one or more UEs in the up-link direction on the first cell in the second time slot.

In a second technique, the UE 1352 receives data transmitted from the transmission component 1310 in the down-link direction in the first time slot. The UE 1352 determines an interference level during the reception in the first time slot. The UE 1352 reports the interference level to the first base station. Upon receiving the reported interference level, The interference detection component 1306 determines, based on the reported interference level, that transmission in the down-link direction at the first base station would interfere with receiving data in the up-link direction at the second base station on the second cell. The scheduling component 1308 determines, in the first time slot, to communicate with the one or more UEs in the up-link direction on the first cell in the second time slot.

In a third technique, the transmission component 1310 transmits data to the one or more UEs in the down-link direction in the first time slot. The interference detection component 1306 determines that the data were not successfully received at the one or more UEs. The interference detection component 1306 further determines that transmission in the down-link direction at the first base station would interfere with receiving data in the up-link direction at the second base station on the second cell. Based on that determination, the scheduling component 1308 determines, in the first time slot, to communicate with the one or more UEs in the up-link direction on the first cell in the second time slot.

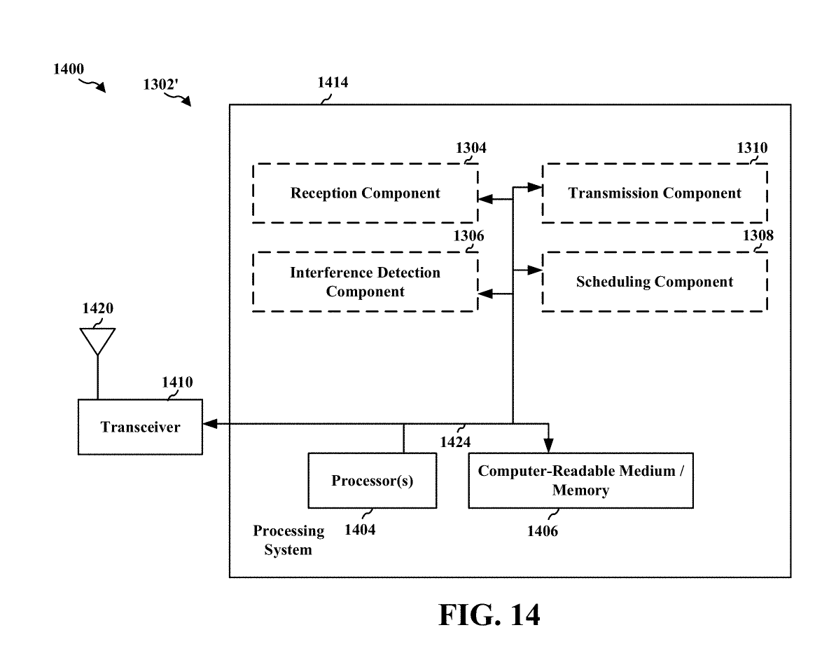

FIG. 14 is a diagram 1400 illustrating an example of a hardware implementation for an apparatus 1302′ employing a processing system 1414. The apparatus 1302′ may be a base station. The processing system 1414 may be implemented with a bus architecture, represented generally by a bus 1424. The bus 1424 may include any number of interconnecting buses and bridges depending on the specific application of the processing system 1414 and the overall design constraints. The bus 1424 links together various circuits including one or more processors and/or hardware components, represented by one or more processors 1404, the reception component 1304, the interference detection component 1306, the scheduling component 1308, and the transmission component 1310, and a computer-readable medium/memory 1406. The bus 1424 may also link various other circuits such as timing sources, peripherals, voltage regulators, and power management circuits, etc.

The processing system 1414 may be coupled to a transceiver 1410, which may be one or more of the transceivers 354. The transceiver 1410 is coupled to one or more antennas 1420, which may be the communication antennas 320.

The transceiver 1410 provides a means for communicating with various other apparatus over a transmission medium. The transceiver 1410 receives a signal from the one or more antennas 1420, extracts information from the received signal, and provides the extracted information to the processing system 1414, specifically the reception component 1304. In addition, the transceiver 1410 receives information from the processing system 1414, specifically the transmission component 1310, and based on the received information, generates a signal to be applied to the one or more antennas 1420.

The processing system 1414 includes one or more processors 1404 coupled to a computer-readable medium/memory 1406. The one or more processors 1404 are responsible for general processing, including the execution of software stored on the computer-readable medium/memory 1406. The software, when executed by the one or more processors 1404, causes the processing system 1414 to perform the various functions described supra for any particular apparatus. The computer-readable medium/memory 1406 may also be used for storing data that is manipulated by the one or more processors 1404 when executing software. The processing system 1414 further includes at least one of the reception component 1304, the interference detection component 1306, the scheduling component 1308, and the transmission component 1310. The components may be software components running in the one or more processors 1404, resident/stored in the computer readable medium/memory 1406, one or more hardware components coupled to the one or more processors 1404, or some combination thereof. The processing system 1414 may be a component of the base station 310 and may include the memory 376 and/or at least one of the TX processor 316, the RX processor 370, and the controller/processor 375.

In one configuration, the apparatus 1302/apparatus 1302′ for wireless communication includes means for performing each of the operations at a base station of FIGS. 11-12. The aforementioned means may be one or more of the aforementioned components of the apparatus 1302 and/or the processing system 1414 of the apparatus 1302′ configured to perform the functions recited by the aforementioned means.

As described supra, the processing system 1414 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a wireless communication system, the wireless communication system including a first base station of a first cell, comprising:
determining, at the first base station and prior to a first time slot and a second time slot, to communicate with one or more user equipments (UEs) on the first cell in a first direction in the first time slot and the second time slot, the first time slot and the second time slot being consecutive, the one or more UEs including a first UE;
determining, at the first base station, that communication with the first UE on the first cell in the first direction interferes with communication between a second base station and a second UE on a second cell in a second direction, communication in the second direction having a priority higher that a priority of communication in the first direction; and
determining, at the first base station and in the first time slot, to communicate with the one or more UEs on the first cell in the second direction in the second time slot.

2. The method of claim 1, wherein the first direction is an up-link direction and the second direction is a down-link direction.

3. The method of claim 2, wherein the wireless communication system further includes the first UE, the method further comprising:
receiving, at the first UE, a signal sent from the second base station on the second cell in the first time slot;
refraining, at the first UE, from transmitting data to the first base station in the first time slot based on the signal; and
detecting, at the first base station, that the first UE is refraining from transmitting data to the first base station in the first time slot, wherein the interference with the communication between the second base station and the second UE is determined based on the detection.

4. The method of claim 3, further comprising:
determining, at the first UE and based on a power level of the signal, that transmission in the up-link direction at the first UE interferes with receiving data at the second UE on the second cell in the down-link direction; and
determining, at the first UE, to refrain from transmitting data to the first base station in the first time slot in response to the determination that transmission in the up-link direction at the first UE interferes with receiving data at the second UE on the second cell in the down-link direction.

5. The method of claim 2, further comprising:
receiving, at the first base station, data transmitted from the first UE in the up-link direction in the first time slot; and
determining, at the first base station, an interference level during the reception in the first time slot, wherein the interference with the communication between the second base station and the second UE is determined based on the interference level.

6. The method of claim 2, further comprising:
receiving, at the first base station, data transmitted from the one or more UEs in the up-link direction in the first time slot; and
determining, at the first base station, that the data were not received successfully, wherein the interference with the communication between the second base station and the second UE is determined based on the unsuccessful reception.

7. The method of claim 1, wherein the first direction is a down-link direction and the second direction is an up-link direction.

8. The method of claim 7, further comprising:
receiving, at the first base station, a signal sent from the second base station on the second cell in the first time slot; and
refraining, at the first base station, from transmitting data to the first UE in the first time slot based on the signal, wherein the interference with the communication between the second base station and the second UE is determined based on the signal.

9. The method of claim 8, further comprising:
determining, at the first base station and based on a power level of the signal, that transmission in the down-link direction at the first base station interferes with receiving data at the second base station on the second cell in the up-link direction; and
determining, at the first base station, to refrain from transmitting data to the first UE in the first time slot in response to the determination that transmission in the down-link direction at the first base station interferes with receiving data at the second base station on the second cell in the up-link direction.

10. The method of claim 7, wherein the wireless communication system further includes the first UE, the method further comprising:
receiving, at the first UE, data transmitted from the first base station in the down-link direction in the first time slot;
determining, at the first UE, an interference level during the reception in the first time slot; and
reporting, at the first UE, the interference level to the first base station, wherein the interference with the communication between the second base station and the second UE is determined based on the interference level.

11. The method of claim 7, further comprising:
transmitting, at the first base station, data to the one or more UEs in the down-link direction in the first time slot; and
determining, at the first base station, that the data were not successfully received at the one or more UEs, wherein the interference with the communication between the second base station and the second UE is determined based on the unsuccessful reception.

12. A wireless communication system including a first base station of a first cell, comprising:
a memory; and
at least one processor coupled to the memory and configured to:
determine, at the first base station and prior to a first time slot and a second time slot, to communicate with one or more user equipments (UEs) on the first cell in a first direction in the first time slot and the second time slot, the first time slot and the second time slot being consecutive, the one or more UEs including a first UE;
determine, at the first base station, that communication with the first UE on the first cell in the first direction interferes with communication between a second base station and a second UE on a second cell in a second direction, communication in the second direction having a priority higher that a priority of communication in the first direction; and
determine, at the first base station and in the first time slot, to communicate with the one or more UEs on the first cell in the second direction in the second time slot.

13. The wireless communication system of claim 12, wherein the first direction is an up-link direction and the second direction is a down-link direction.

14. The wireless communication system of claim 13, further including the first UE, wherein the at least one processor is further configured to:
receive, at the first UE, a signal sent from the second base station on the second cell in the first time slot;
refrain, at the first UE, from transmitting data to the first base station in the first time slot based on the signal; and
detect, at the first base station, that the first UE is refraining from transmitting data to the first base station in the first time slot, wherein the interference with the communication between the second base station and the second UE is determined based on the detection.

15. The wireless communication system of claim 14, wherein the at least one processor is further configured to:
determine, at the first UE and based on a power level of the signal, that transmission in the up-link direction at the first UE interferes with receiving data at the second UE on the second cell in the down-link direction; and
determine, at the first UE, to refrain from transmitting data to the first base station in the first time slot in response to the determination that transmission in the up-link direction at the first UE interferes with receiving data at the second UE on the second cell in the down-link direction.

16. The wireless communication system of claim 13, wherein the at least one processor is further configured to:
receive, at the first base station, data transmitted from the first UE in the up-link direction in the first time slot; and
determine, at the first base station, an interference level during the reception in the first time slot, wherein the interference with the communication between the second base station and the second UE is determined based on the interference level.

17. The wireless communication system of claim 13, wherein the at least one processor is further configured to:
receive, at the first base station, data transmitted from the one or more UEs in the up-link direction in the first time slot; and
determine, at the first base station, that the data were not received successfully, wherein the interference with the communication between the second base station and the second UE is determined based on the unsuccessful reception.

18. The wireless communication system of claim 12, wherein the first direction is a down-link direction and the second direction is an up-link direction.

19. The wireless communication system of claim 18, wherein the at least one processor is further configured to:
receive, at the first base station, a signal sent from the second base station on the second cell in the first time slot; and
refrain, at the first base station, from transmitting data to the first UE in the first time slot based on the signal, wherein the interference with the communication between the second base station and the second UE is determined based on the signal.

20. A computer-readable medium storing computer executable code for a wireless communication system including a first base station of a first cell, comprising code to:
determine, at the first base station and prior to a first time slot and a second time slot, to communicate with one or more user equipments (UEs) on the first cell in a first direction in the first time slot and the second time slot, the first time slot and the second time slot being consecutive, the one or more UEs including a first UE;
determine, at the first base station, that communication with the first UE on the first cell in the first direction interferes with communication between a second base station and a second UE on a second cell in a second direction, communication in the second direction having a priority higher that a priority of communication in the first direction; and
determine, at the first base station and in the first time slot, to communicate with the one or more UEs on the first cell in the second direction in the second time slot.
